(19) United States
(12) Patent Application Publication
(10) Pub. No.: US 2009/0078216 A1
(43) Pub. Date: Mar. 26, 2009

(54) METHOD AND APPARATUS FOR DETERRING ANIMALS USING APERIODIC NOISE

(75) Inventor: Douglas Bell, Chevy Chase, MD (US)

Correspondence Address: SUGHRUE MION, PLLC, 2100 PENNSYLVANIA AVENUE, N.W., SUITE 800, WASHINGTON, DC, 20037, US

(73) Assignee: Douglas Bell, Chevy Chase, MD (US)

(21) Appl. No.: 11/859,099

(22) Filed: Sep. 21, 2007

(51) Int. Cl. A01K 29/00

(52) U.S. Cl. 119/719

(57) ABSTRACT

Methods and apparatuses are provided for deterring animals from entering or remaining in an area, comprising a motor which twists a twistable member, causing a noise generating member to generate noise by contacting the surface of a container, or a number of objects in the container. A method is also provided for deterring animals by generating randomly varying noises at randomly varying and aperiodic intervals. The method may further be implemented by causing an accumulation of torque in a twistable member, which at aperiodic or randomly varying intervals causes a noise generating member to move against a surface or against objects to produce randomly varying noises.

### BACKGROUND OF THE INVENTION

1. Field of the Invention

The present invention relates to a method and apparatus for deterring animals from entering or remaining in an area through the use of noise.

2. Description of the Related Art

Wildlife can cause considerable damage as they enter and feed in fields, yards, and gardens. Much of this feeding is done in the hours between dusk and dawn. Fences, chicken wire, and other obstructions have been used to keep such animals at bay. However, fences used to exclude deer and other large animals must be extremely high and sturdy, or electrified. Thus, the costs and aesthetics obviate the use of fencing in many settings. Other obstructions such as chicken wire remain inconvenient to use, and may be seen as detrimental to the aesthetic appeal of a garden or yard. Some of these solutions may also violate zoning ordinances or restrictive covenants.

Birds may also become a nuisance in urban areas such as the roofs of buildings. Known methods of deterring birds from congregating include the use of noxious-smelling chemicals, loud noises, or metallic strips. These methods soon become ineffective, however, because birds quickly habituate to a steady stimulus. As a last resort, birds are often destroyed, much to the dismay of animal-rights activists and others.

The use of scarecrows or periodic and repetitive noise-making devices are generally ineffective after a period of time, because animals often become accustomed to periodic or predictable stimulation.

Natural and chemical repellents are available in the form of odor repellents for treating an area, or contact repellents for imbuing plants with a foul taste. Many chemicals, such as denatonium benzoate and thiram have been tried, as well as mixtures of chemicals with hot sauce, eggs, and glue. Natural substances have been employed, such as extracts of the African Marigold, coyote urine, lion feces, fermented blood, shredded deodorant soap, garlic, feather meal, cat feces, moth balls, creosote, and bags of human hair. These repellents are of questionable efficacy, require constant reapplication, are malodorous, and are often toxic.

Solutions such as propane guns or a series of small explosive charges have also been employed, but are clearly inappropriate for more urban environments, and generate loud noises disturbing to any nearby humans. Such solutions also require close oversight, and are therefore time-consuming to implement.

Devices using laser beams to sweep a field in vertical and horizontal patterns have also been used, but may suffer from problems such as high cost, complexity, high power consumption, and complex set-up and operation. Although such devices may be suitable for a large farm, they are not suitable for most areas, including more urban environments, or cases in which a number of smaller areas of various shapes and sizes must be protected, as in a garden.

Some devices use a spray of water to scare off animals, but such devices necessitate bringing water lines to the area needing protection. Further, water lines are subject to freeze damage in winter, which is a time when much animal damage occurs, and repeatedly spraying foliage with water invites disease problems in plants. A further limitation of such devices is that they will also wet people who might periodically enter the designated area for recreation or work.

Various electronic devices that are activated by infra-red heat or motion sensors have been developed to deter such animals, but each of these devices has limitations.

Some devices have heat or motion sensors that activate audiotapes of barking dogs or other repetitive noises. Wild animals such as deer typically habituate to such noises, rendering these methods ineffective.

Some devices activate lights or radios upon detection of an animal, which can disturb sleeping neighbors or owners, and cause light pollution at night. Moreover, repetitive noises, lights, or radios, are generally annoying and disturbing to humans in the area.

Sensor-based devices are also prone to failure with respect to smaller animals. These devices may or may not properly detect the presence of an animal, and therefore may fail to deter such animals from entering or remaining in the area of concern.

Some devices attempt to cause an unpleasant sensation such as dizziness or nausea in interloping animals, through the use of microwaves, vibration, or supersonic noise waves. Although some such devices may be considered humane, as they do no permanent damage, many would prefer a device which avoids causing such unpleasant sensations. Furthermore, although such devices may be harmless to some animals, they may yet have a harmful effect on smaller animals, or unpredictable effects on insects, worms, or other creatures important to the local ecosystem or to the soil.

Thus, there is a need for a low-cost device that causes no harm to animals or the environment, and causes no harm, inconvenience, or annoyance to humans who are nearby or who enter the protected area. Such a device must effectively deter animals from entering or remaining in a protected area, and prevent such animals from becoming habituated to its operation, in order to maintain its deterrent effect over time.

### SUMMARY OF THE INVENTION

Exemplary embodiments of the present invention have been provided to address at least the above problems or disadvantages, and to provide at least the advantages described below. Accordingly, an exemplary aspect of embodiments of the present invention is to provide an animal deterrent apparatus and an animal deterrent method, which can deter animals from entering or remaining in an area.

The foregoing and other objects and advantages are substantially realized by providing an animal deterrent method, according to embodiments of the present invention, which comprises rotating a twistable, torque accumulating member coupled to a noise-generating member at least until said twistable member releases its stored energy to causes said noise-generating member to rotate and generate noise.

The rotating may be performed by a motor. The noise generating member may generate noise through contact with a hard surface, such as an inner surface of a container, or the surface of one or many small hard objects.

The noise generating member may be a hard and relatively heavy object of a variety of shapes or sizes. The twistable member may be a cord, wire or band, and may be made of various types of plastic, such as the nylon cord commonly used in weed trimming devices, or may alternatively be made of stranded or braided metal.

The noise generating member may further extend in at least one direction away from the area of said hard object at which said twistable member is coupled to said hard object.

The twistable member may be made to accumulate torque when twisted, until releasing said torque causes said noise-generating member to rotate and generate noise.

The method may be performed so that releasing said torque causes said noise-generating member to generate noise by causing said noise-generating member to contact a nearby object. The nearby object may be a hard inner surface of a container or one or many small hard objects, for example.

According to another aspect of embodiments of the present invention, a method is provided comprising generating noise at intervals containing substantially random variations. The noise generated at each interval may further contain substantially random variations in quality.

The variations in quality may comprise variations in at least one of a volume of the noise, a duration of the noise, a periodicity of the noise, a frequency of the noise, a type of an object or objects which the noise appears to represent, and an orientation of an object or objects which the noise appears to represent.

The periods between generation of noise may be comprised of accumulating torque in a twistable member.

The accumulation of torque is accomplished by rotating the twistable member, which may be a plastic cord, through use of a motor.

According to another aspect of embodiments of the present invention, an apparatus is provided, comprising a motor; a twistable member; and a noise-generating member; wherein said motor is coupled to said twistable member; said twistable member is coupled to said noise-generating member; and said motor rotates said twistable member at least until said twistable member causes said noise-generating member to rotate and generate noise.

The noise-generating member may generate noise at aperiodic intervals, or at intervals containing substantially random variations.

The noise-generating member may generate noise through contact with a hard surface, such as an inner surface of a container, or a surface of one or many small hard objects, for example.

The noise-generating member may be a hard and relatively heavy object, which may extend in at least one direction away from the area of said hard object at which said twistable member is coupled to said hard object.

The twistable member may be at least one of a cord and a wire, which may comprise plastic or metal, and may be, for example, a nylon cord.

The twistable member may accumulate torque when twisted, until releasing said torque causes said noise-generating member to rotate and generate noise.

The method may be performed so that releasing said torque causes said noise generating member to generate noise by causing said noise generating member to contact a nearby object, which may be at least one of a hard inner surface of a container and one or many small hard objects.

### BRIEF DESCRIPTION OF THE DRAWINGS

The above and other aspects of the present invention will be made more apparent through a description of certain exemplary embodiments of the present invention, with reference to the accompanying drawings, in which:

FIG. 1 illustrates a view of an exemplary embodiment of the invention.

### DETAILED DESCRIPTION OF EXEMPLARY EMBODIMENTS

Certain exemplary embodiments of the present invention will now be described in greater detail with reference to the accompanying drawing.

In the following description, elements specifically defined in this specification are provided to assist in a comprehensive understanding of the invention. It is apparent that the present invention can be carried out without those specifically defined elements. Well-known functions or constructions are not described in detail since they would obscure the invention with unnecessary detail.

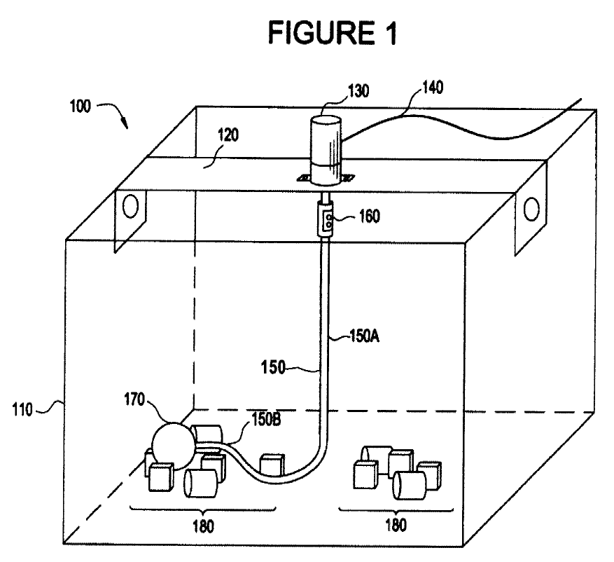

FIG. 1 shows an exemplary embodiment of the invention. In FIG. 1, the deterrent device 100 includes a container 110, a support 120, a motor 130, one or more electrical cables 140, a twistable member in the form of a cord 150, a cord guide 160, a hard noise making member 170, hereinafter referred to as a striker, and noise enhancing objects 180, hereinafter referred to as target objects.

The container 110, for example, may be a cylindrical plastic container, such as a plastic pail; however, many other containers would be equally effective, such as a wooden box or a metal pail. The support 120 is suspended across the center of the container 110. In other embodiments, the support 120 may be disposed away from the center, or towards a side of the container 110, and so need not necessarily be located in the center, and need not be horizontally disposed. In use, the entire apparatus may be disposed at a tilt angle of up to 90 degrees from the position illustrated, it being preferred only that the motor shaft, and thus the motor-end of the twistable member, be somewhat elevated with respect to the lowest area of the container.

The support 120 is coupled to a motor 130, which is powered by electrical cables 140. In other embodiments, the motor 130 may be powered by a battery, by solar power, or by other convenient means. In other embodiments, the motor 130 could also be attached to a side or bottom of the container, so that support 120 would no longer be needed.

The motor 130 is coupled to a twistable member 150, which is suspended from the motor 130, and extends in a downward direction towards the bottom of the container 110. The motor 130 is coupled to the twistable member 150 so as to rotate or twist the twistable member 150 when activated. The twistable member 150 may be a cord made from nylon, for example, and it has been found through experimentation that nylon cords of the type sold for use in typical weed trimmers (so-called string trimmers) are effective for use in the invention. Although in this particular embodiment, a plastic cord is indicated, other types of twistable flexible materials may easily be substituted. For example, metal stranded wire, metal braided wire, metal cable, rope, or leather, could potentially be employed in place of a plastic cord.

A guide 160, attached to a side of the container 110, may be employed to help guide the twistable member 150. In other embodiments, the guide 160 could be attached, for example, to the support 120.

As may be seen in FIG. 1, the twistable member 150 has a vertical portion 150A, and a portion 150B laying along the bottom of the container. Thus, in the present exemplary embodiment, the twistable member 150 is longer than the distance between the bottom surface of the container 110 and the motor 130. In other words, the twistable member 150 has a certain degree of initial slack, and hangs so that the hard noise-making member or striker 170 can lie on the bottom surface of the container 110, or on the noise enhancing target objects 180. The twistable member 150 is coupled to the hard noise-making striker 170. The striker member 170, could comprise, for example, a hard piece of wood, a metal bar, or other objects which create noise when making contact with the surface of the container or noise enhancing target objects 180 disposed within the container. The member 170 is sufficiently heavy that it cannot be easily rotated by the twistable member.

In operation, the deterrent device 100 is placed in an area, such as a garden or yard, to be protected from animals. The motor 130 is activated by plugging in the electrical cable 140. Alternatively, a power switch may be provided on the deterrent device 100. As the motor 130 rotates, it twists the twistable member 150. Due to rotation by the motor 130, potential energy or torque is stored or accumulated in the twistable member 150, which, in addition to twisting, may form a number of loops. The relatively heavy and solid hard object or “striker” is coupled to the opposite end of the said twistable member. In operation, the motor runs continuously so as to apply a twisting force, or torque, to the “motor end” of the twistable member. As the motor shaft (which is firmly coupled to the “motor end” of the twistable member) continues to rotate, the opposite end of the said twistable member cannot rotate freely due to the greater or lesser resistance to said rotation imposed by the weight of the striker and the inertia inherent therein, frictional forces acting on the striker, and possibly further resistance added by the target objects.

As the motor continues to rotate (twist) the motor end of the twistable member, said member gradually accumulates more and more energy, due to the fact that rotation of the opposite end, to which the relatively weighty and heavy striker is attached, is opposed by the striker's inherent inertia and friction. Thus, the resistance to rotation at the striker end of the twistable member causes the twistable member to become, as the motor shaft continues to rotate, more and more twisted, or “wound up.”

The striker, due to its weight, friction, and inertia, remains at rest and generally does not respond to the continuing rotation of the motor and the increasing torque imposed upon the twistable member and the increasing energy stored therein, during the “winding up” process. However, as the described torque and latent energy progressively build up, a release event or “avalanche” ultimately occurs, when the twisting force at the striker end of the twistable member equals and then for an instant, exceeds the striker's aforementioned resistance to rotation. The striker is thereupon set violently into a rotary motion, driven by the energy stored in the twistable member. The said violent spinning motion of the striker, after some time, dissipates most or all of the energy which was built up in the twistable member prior to the avalanche.

The system is now returned substantially to its original low latent energy condition, whereas the motor shaft continues to turn and begins once again to store torque in the twistable member, which had, after the avalanche, become substantially relaxed (unwound or untwisted). Since there is little or no energy remaining in the then untwisted twistable member, the heavy striker once again remains quietly at rest as the twistable member begins again to store energy for the next avalanche event.

The aforementioned striker, driven by the twistable member, can thus be made to violently and convulsively rotate, during the avalanche phase of operation, for such a longer or shorter period of time as may be necessary to dissipate the aforementioned stored energy of the twistable member.

The aperiodic rotational movement of the striker may be employed to create noises effective in startling and thereby deterring birds and animals of many kinds. The striker may be arranged in closed proximity to none or to any number of the loose sound-generating objects/targets placed in the housing by the user of the invention. During its rotation, the striker may contact, in an altogether random manner, the housing itself, and an unpredictable number of the said loose targets, which if and when struck, are propelled or projected with some energy and violence against each other and against the walls of the housing. Preferably the loose targets are composed of an assortment of hard materials (e.g., metals, plastics, ceramics, and so forth), and of differing shapes and sizes, so that the generated noise has a quite different characteristic upon each release event.

The loose targets are so arranged, prior to the avalanche event, that they are at rest, possibly in contact with each other and, as to some few of them, in contact with the striker. When the striker embarks upon its violent rotation, the said loose targets are thrown about within the housing, creating unpredictable random sounds. When the rotation of the striker ceases, the said targets come to rest once again, in an altogether random fashion, awaiting the next rotation of the striker.

It is to be observed that the targets, and the random manner in which they may scatter or “pile up” near, around, or atop the striker, influence the operation of the device and each successive avalanche event. The targets, once having come to rest after having been flung around by the striker, may to a greater or lesser degree hinder the rotation of same, depending upon how they happen to land, in relation to the striker. If heavier targets are used, and one or more come to rest atop the striker, more force will naturally be required to overcome the striker's increased resistance to movement caused by the added burden of the targets. As the striker thereby gains increased resistance to rotation, the twistable member must be twisted more tightly to trigger the avalanche. Thus, the time required for the twisting (the winding-up) of the twistable member varies infinitely, according to no pattern whatever, due to the face that the arrangement of the target objects is, as a practical matter, never the same, from one rotation of the striker to the next.

The rotational or spinning episodes of the striker may be conveniently influenced by the user simply by varying the number, size, quantity shape, and composition of the target objects. Similarly, the quality of the sounds produced may be conveniently varied merely by changing one or more of the said target objects. To the same ends, the size, shape and weight of the striker (or strikers) may be changed and the same may be detached from and reattached to the twistable member by means of suitable conventional connectors or other fasteners.

Thus, It is substantially unpredictable when the torque of the twistable member 150 will be released, due the large number of factors or parameters which affect the system, and the sensitive dependence on the initial conditions. Moreover, for the same reasons, the time intervals at which the torque of the twistable member 150 is released are substantially unpredictable in length, and occur at aperiodic intervals containing random variation. The hard noise making striker member 170, may slide along the bottom surface of the container 110, flip or roll during rotation, and through such motions create different noises. The variety of sounds generated is broadened, by, for example, using many hard target members 170, for example, comprised of metal balls, plastic balls, metal bars or disks, marbles, golf balls, pieces of wood, stones, glass, pieces of metal, etc. As would be understood by one of ordinary skill in the art, the striker 170 and the noise making target objects 180 may comprise a variety of materials and shapes, and the target objects in particular may be varied by the user as desired.

That is, the noise enhancing target objects 180 may be easily changed or replaced in order to change the intervals between noises or the properties of the noise generated. Moreover, almost any objects may be employed as the target objects 180, as long as they are of appropriate size for the container 110. However, one of ordinary skill in the art may easily envision other embodiments in which a standard set of objects may be employed as the target objects 180, or in which a user of the embodiment is discouraged or not permitted to change or replace the noise making objects 180.

The embodiment described above results in the generation of unnatural-sounding noise, because the noise has a random variation in quality, and random variation in interval. Because the release events occur at intervals of time which vary randomly or unpredictably, animals do not habituate to the noise.

Due to the relatively heavy weight of the striker member in particular, the release event may also cause a slight rocking or wobbling motion of the container 110 at the time of release, which adds to and the unnatural character of the noise generated, and provides an additional deterrent effect.

With, or even without the noise enhancing target objects 180, the type and quality of noise generated each time the striker member 170 moves is different, for example, in volume, pitch, periodicity, or frequency, or in terms of what objects, motions, or orientations of objects the noise appears to represent. This variation also enhances the aspect of the invention which prevents animals from habituating to the deterrent noise.

The foregoing embodiments and features are merely exemplary, and are not to be construed as limiting the present invention. The present teaching can be readily applied to other types of apparatuses. The description of the exemplary embodiments of the present invention is intended to be illustrative, and not to limit the scope of any claim; many alternatives, modifications, and variations will be apparent to those skilled in the art.

1. A method for deterring animals, comprising:
disposing a twistable member at least partially within a container containing at least one noise-generating member:
rotating one end of said twistable member to accumulate energy therein, a second end of said twistable member being coupled to said noise-generating member, at least until said second end of said twistable member also rotates to cause said noise-generating member to generate noise.

2. The method of claim 1, wherein said rotating is performed by a motor.

3. The method of claim 1, wherein said noise-generating member generates noise through contact with a hard surface.

4. The method of claim 3, wherein said hard surface is an inner surface of said container.

5. The method of claim 3, wherein said hard surface is a surface of a small hard object within said container.

6. The method of claim 1, wherein said noise-generating member is a hard object.

7. The method of claim 1, wherein said twistable member is at least one of a cord and a wire.

8. The method of claim 7, wherein said twistable member comprises plastic.

9. The method of claim 8, wherein said twistable member is nylon cord.

10. The method of claim 7, wherein said twistable member comprises a metal cord.

11. The method of claim 6, wherein said noise generating member extends in at least one direction away from the area of said noise generating member at which said twistable member is coupled to said noise generating member.

12. The method of claim 1, wherein said twistable member accumulates said energy as a stored torque when twisted.

13. The method of claim 12, wherein said twistable member releases said torque at unpredictable intervals.

14. The method of claim 12, wherein said twistable member releases said torque at aperiodic intervals.

15. The method of claim 14, wherein said releasing said torque causes said noise-generating member to generate noise.

16. The method of claim 15, wherein said releasing said torque causes said noise-generating member to generate noise by causing said noise-generating member to contact a nearby object.

17. The method of claim 16, wherein said nearby object is at least one of a hard inner surface of a container and a small hard object.

18. A method for deterring animals, comprising generating noise at intervals containing substantially random variations through the use of a torque accumulating member whose energy release occurs at uncontrolled intervals, and wherein the noise generated at each interval contains substantial variations in quality.

19. (canceled)

20. The method of claim 19, wherein the variations in quality comprise variations in at least one of a volume of the noise, a duration of the noise, a periodicity of the noise, a frequency of the noise, a type of an object or objects which the noise appears to represent, and an orientation of an object or objects which the noise appears to represent.

21. The method of claim 18, wherein the generating noise further comprises accumulating torque in a twistable member which releases said torque at unpredictable intervals.

22. (canceled)

23. The method of claim 21, wherein said twistable member releases said torque at aperiodic intervals.

24. The method of claim 21, wherein the accumulating torque further comprises rotating the twistable member through use of a motor.

25. The method of claim 24, wherein the twistable member is a plastic cord.

26. An apparatus for deterring animals, comprising:
a motor;
a twistable member; and
a noise-generating member;
wherein said motor is coupled to one end of said twistable member;
said twistable member is coupled at a second end to said noise-generating member; and
said motor rotates said one end of said twistable member to accumulate energy therein, until at least a subsequent time when the accumulated energy in said twistable member is sufficient to cause rotation of said second end, to release said energy and cause said noise-generating member to generate noise.

27-43. (canceled)

44. The apparatus of claim 26, wherein said energy is accumulated in the form of torsional energy, within said twistable member, and wherein said second end and said noise-generating member are rotated when the sum of all static forces acting on said noise generating member are exceeded by the accumulated torsional energy stored in said twistable member.

45. The apparatus of claim 44, wherein said noise generating member strikes one or more hard objects within said container when it rotates, to create a noise which is startling to animals.
